(19) United States
(12) Patent Application Publication
(10) Pub. No.: US 2009/0044205 A1
(43) Pub. Date: Feb. 12, 2009

(54) ELECTRONIC APPLIANCE, SERVICE OFFERING METHOD, AND RECORDING MEDIUM

(75) Inventors: Sachiko Yoshimura, Osaka (JP); Shigenaka Kanemitsu, Osaka (JP); Takashi Araki, Osaka (JP); Ryusuke Nakatani, Osaka (JP)

Correspondence Address: FROMMER LAWRENCE & HAUG, 745 FIFTH AVENUE- 10TH FL., NEW YORK, NY, 10151, US

(73) Assignee: KYOCERA MITA CORPORATION, Osaka (JP)

(21) Appl. No.: 12/184,367

(22) Filed: Aug. 1, 2008

(30) Foreign Application Priority Data
Aug. 10, 2007 (JP) 2007-209619

(51) Int. Cl. G06F 9/44

(52) U.S. Cl. 719/328

(57) ABSTRACT

The present invention teaches and claims an electronic appliance for controlling a device via a controller comprises an application managing unit, a storing unit, a controller API and a secondary API. The application managing unit manages an application. The application is prepared with the use of an API, which operates the device to offer a service to a user, and is selected upon activation of the electronic appliance. The storing unit stores information about a correlation between the application and the API. The controller API is called by the application, and issues a request to the controller such that the controller operates the device. The secondary API has an interface so as not to be implemented in the controller API, and is called by the application on the basis of any correlation information, which consequently starts up the application with the use of the interface when version information of the API is newer than version information of the controller API.

### INCORPORATION BY REFERENCE

This application is based upon and claims the benefit of priority from the corresponding Japanese Patent Application No. 2007-209619, filed Aug. 10, 2007, the entire contents of which is incorporated herein by reference.

### FIELD OF THE INVENTION

The present invention teaches and claims an electronic appliance capable of offering any utilitarian function based on an application to a user. The present invention also teaches and claims a service offering method and a recording medium.

### BACKGROUND OF THE INVENTION

Conventionally, an electronic appliance, for example, an image forming apparatus has an application installed thereon. The application allows a device (e.g., a printer, a scanner, a facsimile) of the image forming apparatus to offer a requested utilitarian function also known as a service to a user.

In order to offer the service, a technique is adopted by using an API (Application Program Interface). Specifically, the application calls a controller API, and the controller API issues a request to a controller such that the controller operates the device. When the controller operates the device, the image forming apparatus offers the service to the user based on the application.

### SUMMARY OF THE INVENTION

According to one aspect of the present invention, there is provided an electronic appliance comprising an application managing unit, a storing unit, a controller API (Application Program Interface) and a secondary API. Herein, the application managing unit manages an application. The application is prepared with the use of an API, and operates the device to offer a service to a user. The storing unit stores information about a correlation between the application and the API. The controller API is called by the application, and issues one or more requests to a controller such that the controller operates the device. A secondary API has an interface though not to be implemented in the controller API, and starts up the application with the use of the interface when version information of the API is newer than version information of the controller API.

According to another aspect of the present invention, there is provided a method for offering a service based on an application to a user in such a manner that an electronic appliance controls a device via a controller. The method comprises the steps of receiving a command from a user to start up the application prepared with the use of an API, loading the correlation information between the application and the API from a storing unit, a step of issuing at the application managing unit, calling a secondary API on the basis of the correlation information having an interface not to be implemented in a controller API, starting up the application with the use of the interface in the secondary API when version information of the API is newer than version information of the controller API, calling the controller API, issuing a request from the controller API to the controller such that the controller operates the device, and operating the device in accordance with a request.

According to still another aspect of the present invention, there is provided a recording medium to record a program for offering a service based on an application to a user in such a manner that an electronic appliance controls a device via a controller. The program allows a computer of the electronic appliance to execute the steps of receiving a command from the user so as to start the application prepared with the use of an API, loading a correlation information between the application and the API from a storing, a process of issuing at the application managing unit, calling a secondary API on the basis of the correlation information having an interface not to be implemented in a controller API, starting up the application with the use of the interface in the secondary API when version information of the API is newer than version information of the controller API, calling the controller API, issuing a request from the controller API to the controller such that the controller operates the device, and operating the device in accordance with a request.

The above and other objects, features and advantages of the present invention will become more apparent from the following detailed description of the present invention when taken in conjunction with the accompanying drawings.

In this text, the terms “comprising”, “comprise”, “comprises” and other forms of “comprise” can have the meaning ascribed to these terms in U.S. Patent Law and can mean “including”, “include”, “includes” and other forms of “include”.

The various features of novelty which characterize the invention are pointed out in particularity in the claims annexed to and forming a part of this disclosure. For a better understanding of the invention, its operating advantages and specific objects attained by its uses, reference is made to the accompanying descriptive matter in which exemplary embodiments of the invention are illustrated in the accompanying drawings which corresponding components are identified by the same reference numerals.

### BRIEF DESCRIPTION OF THE DRAWINGS

The following detailed description, given by way of example, but not intended to limit the invention solely to the specific embodiments described, may best be understood in conjunction with the accompanying drawings, in which:

FIG. 1 shows a block diagram of a system including an MFP (Multi-Function Peripheral) according to one embodiment of the present invention;

FIG. 2 shows a detailed block diagram of the MFP shown in FIG. 1;

FIG. 3 shows a package used upon installation of an application shown in FIG. 1;

FIG. 4 shows a flowchart illustrating the steps of the installation using the package shown in FIG. 3;

FIG. 5 shows information about a correlation between an application and a secondary API each installed in FIG. 4;

FIG. 6 shows a flowchart of events occurring after the installation in FIG. 4;

FIG. 7 shows a conventional relationship between an API used upon preparation of an application and a controller API;

FIG. 8 shows a conventional relationship between the application and the controller API; and

FIG. 9 shows a relationship among an application, a secondary API and a controller API in FIG. 6.

### DETAILED DESCRIPTION OF THE PREFERRED EMBODIMENTS

Reference will now be made in detail to various embodiments of the invention, one or more examples of which are illustrated in the accompanying drawings. Each example is provided by way of explanation of the invention, and by no way limiting the present invention. In fact, it will be apparent to those skilled in the art that various modifications, combination, additions, deletions and variations can be made in the present invention without departing from the scope or spirit of the present invention. For instance, features illustrated or described as part of one embodiment can be used in another embodiment to yield a still further embodiment. It is intended that the present invention covers such modifications, combinations, additions, deletions, applications and variations come within the scope of the appended claims and their equivalents.

An electronic appliance controls a device via a controller to offer a service based on an application to a user. For example, an image forming apparatus offers, as a service, functions of a printer, a scanner and a facsimile. Herein, when version information of an API (Application Program Interface) used upon preparation of an application is newer than version information of a controller API, a secondary API cancels a difference between the two pieces of version information, so that the application runs with certainty. Hereinafter, description will be given of preferred embodiments of the present invention with reference to the accompanying drawings.

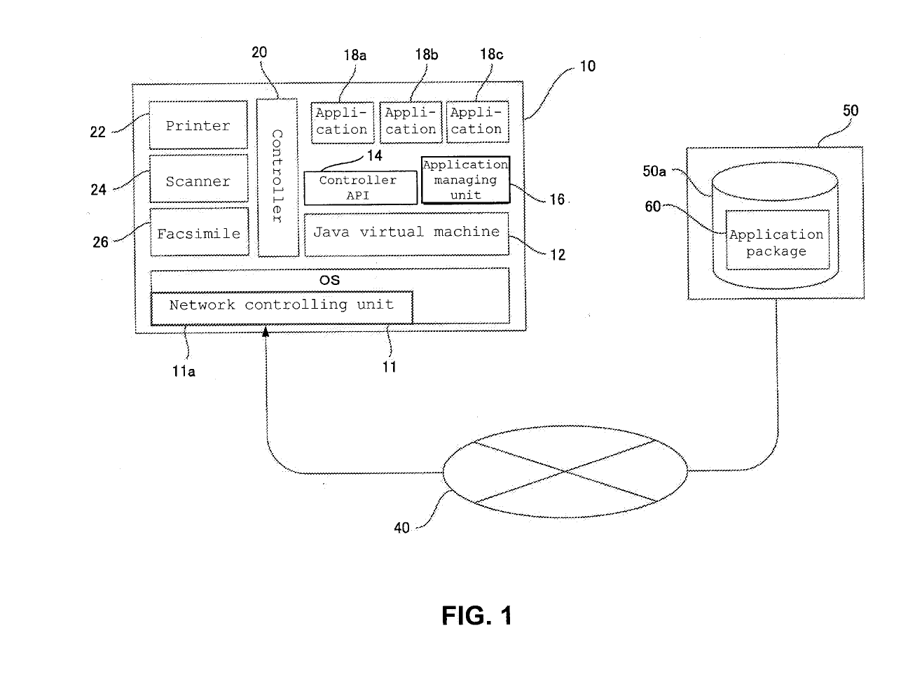

FIG. 1 shows a configuration of a system according to one embodiment of the present invention. The system includes an electronic appliance and a server 50. The electronic appliance may be but not limited to an image forming apparatus or a personal computer. The electronic appliance and the server 50 are connected to the Internet 40.

In this embodiment, as an example, the electronic appliance is an image forming apparatus, particularly, an MFP (Multi Function Peripheral) 10.

The server 50 is owned by an application provider, and includes a database 50a storing an application package 60. This package 60 is distributed to the MFP 10 in accordance with a command from a user. The user can utilize the MFP 10 on the Internet 40.

The MFP 10 includes, but is not limited to, a device, a printer 22, a scanner 24 and a facsimile 26 in addition to a copier.

More specifically, the printer 22 makes one or more copies of an original or prints out a document received by the facsimile 26. The scanner 24 scans the original to generate image data used for copying and/or for transmission via the facsimile 26.

In addition to the printer 22, the scanner 24 and the facsimile 26, the MFP 10 also functions as a network printer and a network scanner, or functions as a network client in a complex manner. Herein, the network printer function or the network scanner function is used throughout a network environment (e.g., a LAN (Local Area Network), a WAN (Wide Area Network)) not including or different from the Internet 40.

The MFP 10 can adopt a well-known basic configuration. That is, the MFP 10 may include at least an ASF (Automatic Sheet Feeder), a sheet supplying unit, a printer engine, a post processor, and the like. The ASF feeds an original to an image scanning point of the scanner 24. The sheet supplying unit supplies a sheet of paper and the printer engine transfers to the sheet of paper, an image formed based on image data. The post processor performs processes such as sorting, punching and stapling on the sheet of paper to which the image has been transferred.

The MFP 10 also includes an operating key and an operating panel through which the user inputs commands. The operating panel displays touch buttons, character information, guidance images and the like.

The MFP 10 also includes a controller 20 that controls operations of the entire MFP 10. The controller 20 is an element serving as a computer and has hardware resources such as a CPU and a memory device.

The controller 20 executes a predetermined program with the use of the hardware resource or an OS (Operating System) 11 corresponding to basic software. The controller 20 operates the respective devices such as the printer 22, the scanner 24 and the facsimile 26 via the OS 11. Herein, the OS 11 has a network controlling unit 11a, and the network controlling unit 11a can be connected to the Internet 40 via the use of a predetermined protocol.

Moreover, according to the embodiment in FIG. 1, the MFP 10 has a plurality of Java® applications 18a, 18b and 18c.

The applications 18a, 18b and 18c are distributed to the MFP 10 in such a manner that the MFP 10 downloads the package 60. The applications are used by the MFP 10 to offer various services to the user.

Specifically, MFP 10 is minimally provided with a Java® virtual machine 12, a controller API 14 and an application managing unit 16.

The user selects one of the applications 18a, 18b and 18c. Then, the application managing unit 16 issues a request to start up the selected application. The selected application calls the controller API 14.

The controller API 14 issues a request to the controller 20 via the virtual machine 12 such that the controller 20 operates the printer 22, the scanner 24 and/or the facsimile 26. When the controller 20 operates the printer 22, the scanner 24 and/or the facsimile 26, the MFP 10 offers the services based on the applications 18a, 18b or 18c to the user.

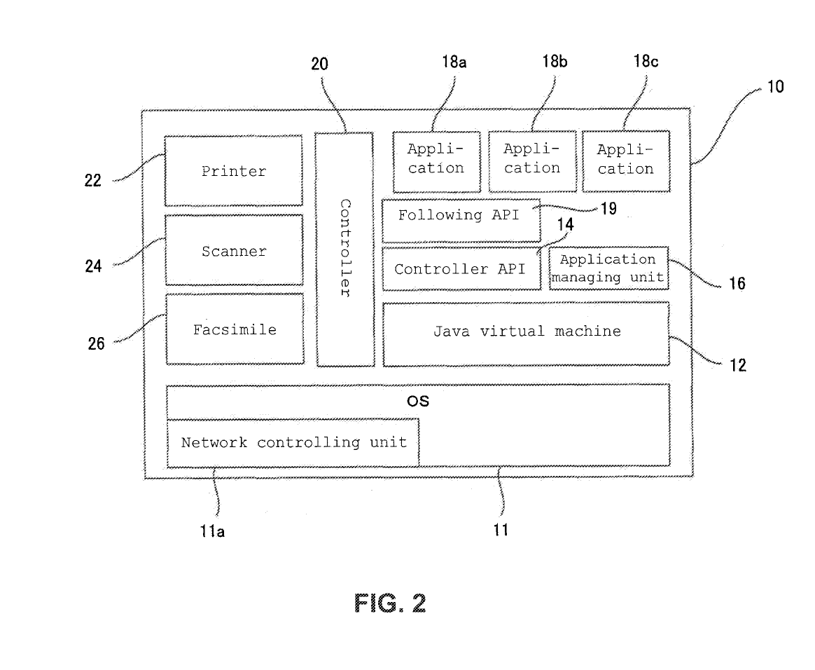

Herein, as shown in FIG. 2, a secondary API 19 is provided between the applications 18a to 18c and the controller API 14.

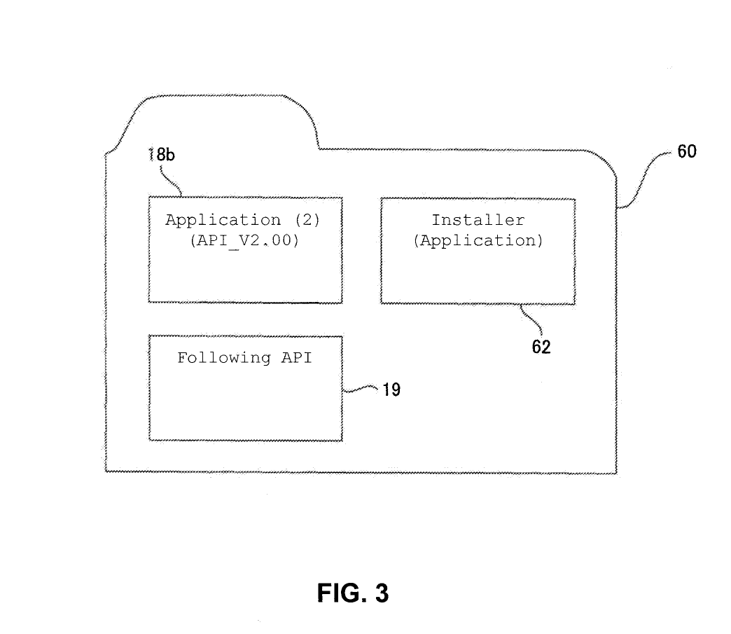

More specifically, applications 18a, 18b and 18c are prepared by a provider, and the provider uses an API in preparation of the application. As an example, FIG. 3 shows the package 60 containing the application 18b (hereinafter, referred to as “Application (2)”). In order to prepare Application (2), the provider uses an API having version information V2.00.

As shown in FIG. 3, the package 60 also contains the secondary API 19 and an installer 62 together with Application (2). At the time of purchase, for example, the MFP 10 has no secondary API 19 provided therein. That is, the secondary API 19 is provided in the MFP 10 whenever necessary.

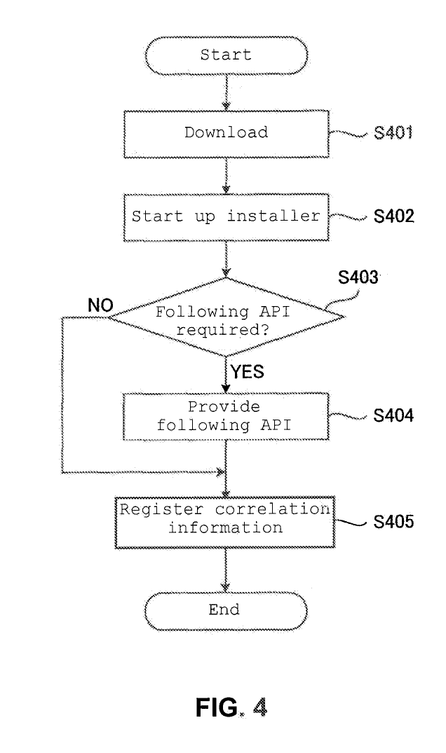

FIG. 4 is a flowchart illustrating the various steps leading to the installation of the package 60.

In step S401, first, the MFP 10 downloads the package 60 via the Internet 40. In step S402, next, the MFP 10 starts up the installer 62 in the package 60. Then, the program proceeds to step S403.

In step S403, the installer 62 determines whether the secondary API 19 should be provided in the MFP 10. Specifically, the installer 62 examines the level of the controller API 14. When the version information of the API used in preparation of Application (2) is newer than (i.e., is larger in number than) version information of the controller API 14, the installer 62 determines that the secondary API 19 should be provided in the MFP 10.

As described above, when the API for Application (2) has the version information V2.00 while the controller API 14 in the MFP 10 has the version information V1.00, the installer 62 makes a determination of “YES” in step S403. Herein, the controller API 14 is incompatible with Application (2). In order to start up Application (2), therefore, the MFP 10 must install the secondary API 19 together with Application (2).

Next step S404, the MFP 10 installs Application (2) and the secondary API 19. Then, the program proceeds to step S405.

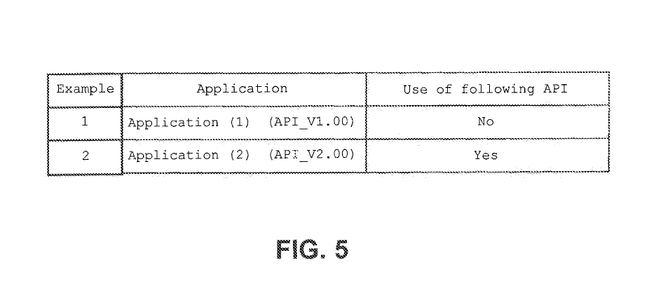

In step S405, the installer 62 registers the application newly installed. Specifically, MFP 10 installs the secondary API 19 together with Application (2) to start up Application (2) with the use of the secondary API 19. The installer 62 then registers a fact that Application (2) requires the secondary API 19 (“Yes” in FIG. 5).

Alternatively, with respect to step S405, it could be the case that the database 50a stores another package 60 containing the application 18a (hereinafter, referred to as “Application (1)”) and an API having version information V1.00 is used in preparation of Application (1). Version information V1.00 of the API used in preparation of Application (1) is equal to the version information V1.00 of the controller API 14; therefore, the installer 62 makes a determination of “NO” in step S403.

In this case, a secondary API 19 contained in the package 60 is not provided in the MFP 10. That is, the MFP 10 installs only Application (1). Then, the program proceeds to step S405. In step S405, since the MFP 10 installs no secondary API 19, the installer 62 registers a fact that Application (1) requires no secondary API (“No” in FIG. 5).

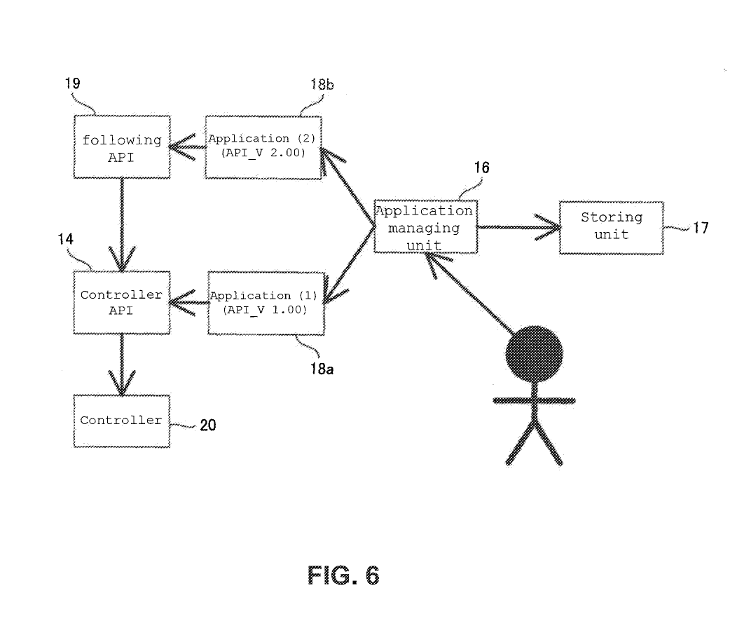

A correlation between the application and the secondary API shown in FIG. 5 is registered in a storing unit 17 (see FIG. 6). In this embodiment, the application managing unit 16 includes the storing unit 17. Herein, the correlation information described above may be registered in another recording area provided in the MFP 10.

FIG. 6 shows a flowchart of events occurring after the installation. Hereinafter, description will be given to the actions of the MFP 10 according to this embodiment of the present invention. Moreover, a method and a program for offering a service with the use of the MFP 10 will be apparent from this description.

First, it is assumed that the user demands 2-in-1 printing (images corresponding to two pages are printed on one side of a sheet of paper) and inputs a command to the MFP 10 so as to start up Application (1). Then, the application managing unit 16 loads the correlation information (indicating the fact that Application (1) requires no secondary API 19) from the storing unit 17. Next, the application managing unit 16 issues a request to Application (1) such that Application (1) runs to call the controller API 14.

Subsequently, when Application (1) calls the controller API 14, the controller API 14 issues a request to the controller 20 such that the controller 20 operates the printer 22. Then, when the controller 20 operates the printer 22, the printer 22 gives to the user a sheet of paper subjected to the 2-in-1 printing as demanded by the user.

In another scenario, the user may demand two-sided printing and input a corresponding command to that demand to the MFP 10 which starts up Application (2). Then, the MFP 10 ensures the start-up of Application (2).

Specifically, the application managing unit 16 loads the correlation information (indicating the fact that Application (2) requires the secondary API 19) from the storing unit 17. Next, the application managing unit 16 issues a request to Application (2) such that Application (2) runs to call the secondary API 19.

Subsequently, Application (2) calls the secondary API 19 and the controller API 14. The secondary API 19 starts up Application (2). In this case, the secondary API 19 supports the 2-in-1 printing as the pseudo service instead of the two-side printing. Consequently, the controller API 14 issues a request corresponding to the 2-in-1 printing to the controller 20. Then, the controller 20 operates the printer 22 in accordance with the request of the 2-in-1 printing. The printer 22 gives the user a sheet of paper subjected to the 2-in-1 printing without being subjected to the two-sided printing as in the similar manner to that previously described.

As described above, according to this embodiment, when the version information of the API used by the application provider to prepare Application (2) is newer than the version information of controller API 14, there is a possibility that Application (2) fails to run.

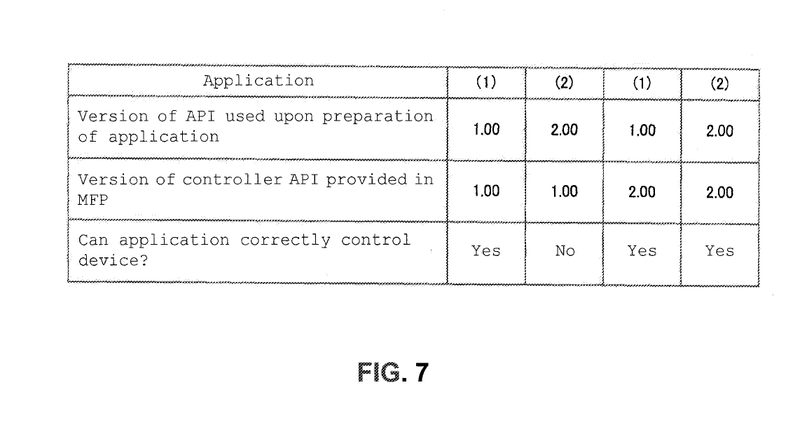

As shown in FIG. 7, more specifically, when the version information of the API used to prepare the application is equal to the version information of the controller API 14 or is older than (i.e., is smaller in number than) the version information of the controller API 14, the application can correctly operate the device such as the printer 22, the scanner 24 or the facsimile 26 (“Yes” in FIG. 7).

In the case of using Application (2), on the other hand, the version information V2.00 of the API used to prepare Application (2) is newer than the version information V1.00 of the controller API 14. As a result, Application (2) fails to correctly operate the device (“No” in FIG. 7).

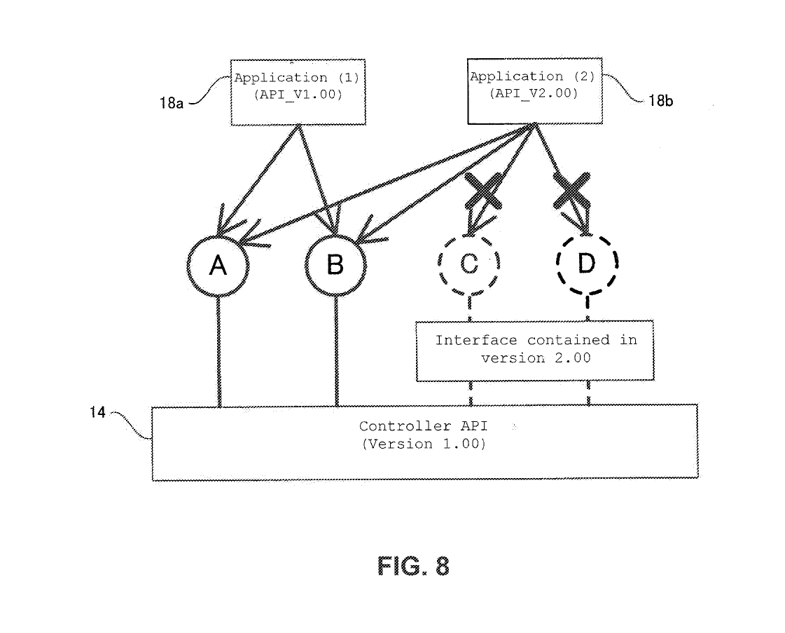

As shown in FIG. 8, more specifically, it is assumed that Application (2) attempts to call the controller API 14. Herein, the controller API 14 is provided originally in the MFP 10 and implements interfaces (A, B). However, the controller API 14 does not implement interfaces (C, D) compatible with the API having the new version information. Consequently, the MFP 10 can not start up Application (2).

When Application (2) fails to run, a service demanded by the user can not be completed promptly with ease due to the following reasons.

First, when Application (2) fails to run even though the user inputs a command which would start Application (2), the status quo corresponds to either 1) a case where Application (2) incompatible with the controller API 14 has been installed on the MFP 10 or 2) a case where the installation of Application (2) has not been completed yet in the MFP 10, that is, the status quo becomes unclear. In the latter case, when the installation of Application (2) has not been completed in the MFP 10, Application (2) must be re-installed on the MFP 10 again. In this situation, a long period of time would be necessary before the completion of a service demanded by the user.

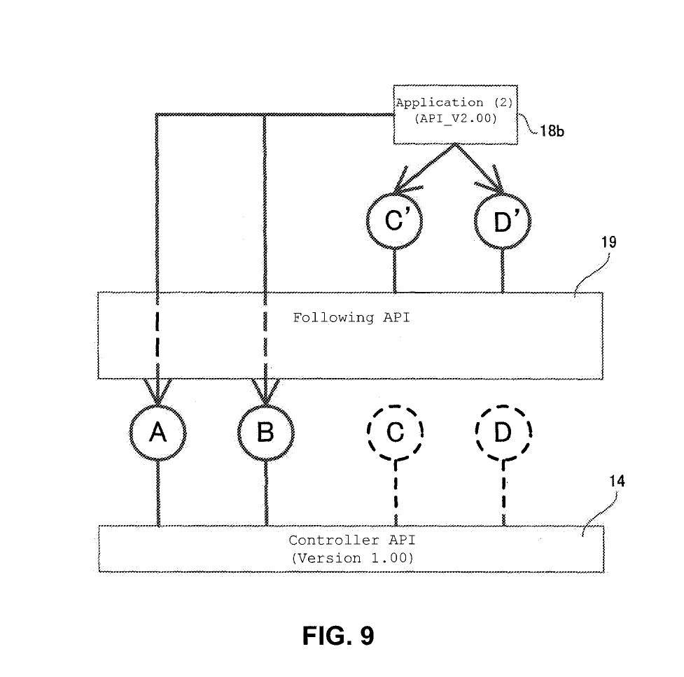

In the embodiment shown in FIG. 9, the secondary API 19 is provided in the MFP 10 when the MFP 10 issues a request to start up Application (2). Herein, the secondary API 19 makes up for the API used to prepare Application (2), and has temporary interfaces (C′, D′). The temporary interfaces (C′, D′) are different from the interfaces (A, B) of the controller API 14 and are compatible with the API used to prepare Application (2). Thus, the interfaces (C′, D′) allow the start-up of Application (2).

In addition, the secondary API 19 cancels a difference between the version information of the API used upon preparation of Application (2) and the version information of the controller API 14. This configuration eliminates a necessity of developing Application (2) for each type of various MFPs.

However, the version information of the API used to prepare Application (2) is different from the version information of the controller API 14. In this embodiment, therefore, the MFP 10 fails to perform the two-sided printing.

With the use of the temporary interfaces (C′, D′), the secondary API 19 supports a pseudo service different from the service based on Application (2), for example, 2-in-1 printing which does not completely coincide with the service demanded by the user.

Thus, it becomes obvious that Application (2) runs with certainty, so that the user recognizes a fact that the status quo corresponds to the case where Application (2) which is incompatible with the controller API 14 has been installed on the MFP 10. Therefore, Application (2) may not be installed on the MFP 10 again leading to prompt completion of the service demanded by the user. This configuration contributes to an improvement of reliability of the MFP 10 because the status quo becomes clear.

Moreover, the MFP 10 installs the secondary API 19 together with Application (2) only in the case of requiring the secondary API 19. Therefore, the MFP 10 does not need to hold APIs more than necessary. This configuration prevents the performance of the MFP 10 from being deteriorated.

Further, the application managing unit 16 issues a request to Application (2) such that Application (2) runs on the basis of the stored correlation information to call the secondary API 19; therefore, Application (2) can run with certainty.

While the present invention has been shown and described in detail, the foregoing description is in all aspects illustrative and not restrictive. It is therefore understood that numerous modifications and variations can be devised without departing from the scope of claims for patent.

In the foregoing embodiment, for example, the secondary API 19 offers the user a pseudo service different from the service based on Application (2); however, the present invention is not particularly limited thereto. Alternatively, the secondary API 19 may notify the user of a fact that the service based on Application (2) is unavailable. In such a case, it becomes obvious that Application (2) runs with certainty.

Moreover, the application provider can freely change the behavior of the secondary API 19 to the user as long as the secondary API 19 can start Application (2).

In addition, a plurality of subsequent APIs each of which is functionally equal to the secondary API 19 may be provided in the MFP 10. In such a case, the APIs can be correlated with different applications, respectively.

Upon distribution, the program for offering the service may be recorded in, but not limited to, a computer-readable recording medium such as a ROM (Read Only Memory), a hard disc, a flexible disc, a memory card or a magneto-optical disc.

Next, the electronic appliance loads the program from the recording medium, so that the program allows the respective components in the electronic appliance to execute various processes.

The present invention is summarized as follows from the foregoing embodiments. The electronic appliance according to one aspect of the present invention is an electronic appliance comprising an application managing unit, a storing unit, a controller API and a secondary API. Herein, the application managing unit manages an application. The application is prepared with the use of an API, and operates the device to offer a service to a user. The storing unit stores information about a correlation between the application and the API. The controller API is called by the application, and issues one or more requests to a controller such that the controller operates the device. The secondary API has an interface not to be implemented in the controller API, and starts up the application with the use of the interface when version information of the API is newer than version information of the controller API.

Herein, the secondary API may be called by the application on the basis of the correlation information. And the application may be selected upon activation of the electronic appliance.

According to one aspect of the present invention, the electronic appliance includes the controller API, the controller and the device. The electronic appliance also includes the application managing unit that manages the application, and the application offers the service to the user. Specifically, the application calls the controller API, and the controller API issues the request to the controller such that the controller operates the device. When the controller operates the device, the electronic appliance offers the service based on the application to the user.

Herein, the application is prepared with the use of the API. When the version information of the API is newer than the version information of the controller API, there is a possibility that the application fails to run because the controller API provided in the electronic appliance has no interface compatible with the API having the new version information.

However, the electronic appliance according to another aspect of the present invention includes the secondary API. The interface of the secondary API which is different from the interface of the controller API can start up the application.

Moreover, the secondary API cancels the difference between the version information of the API used to prepare the application and the version information of the controller API. This configuration eliminates a necessity of developing an application for each type of various electronic appliances.

The electronic appliance also includes the application managing unit and the storing unit. On the basis of the stored correlation information, the electronic appliance starts up the selected application so as to call the secondary API. Therefore, the application runs with certainty.

In a preferred embodiment, the secondary API supports a pseudo service different from the service based on the application, and the controller API issue the request corresponding to the pseudo service.

Herein, at least one pseudo service supported by the secondary API may be a 2-in-1 printing.

With this configuration, the electronic appliance can offer the pseudo service even when the version information of the API is newer than the version information of the controller API. Therefore, it becomes obvious that the application runs with certainty, leading to prompt completion of the service demanded by a user. This configuration contributes to an improvement of the electronic appliance's reliability.

Preferably, the secondary API notifies the user of a fact that the service based on the application is unavailable.

With this configuration, the user can receive the fact that he/she cannot use the service based on the application. Also in this case, it becomes obvious that the application runs with certainty.

In a more preferred embodiment, the secondary API is packaged together with the application, and is installed together with the application on the electronic appliance only in a case where the version information of the API is newer than the version information of the controller API at a time when the application is installed on the electronic appliance.

With this configuration, the secondary API is installed together with the application on the electronic appliance only in the case where the electronic appliance requires the secondary API. This configuration can prevent the performance of the electronic appliance from being deteriorated.

The service offering method according to another aspect of the present invention is a method for offering a service based on an application to a user in such a manner that an electronic appliance controls a device via a controller. The method comprises steps of (1) receiving a command from a user to start up the application prepared with the use of an API, (2) loading the correlation information between the application and the API from the storing unit, (3) calling a secondary API on the basis of the correlation information having an interface not to be implemented in a controller API, (4) starting up the application with the use of the interface in the secondary API when version information of the API is newer than version information of the controller API, (5) calling the controller API, (6) issuing a request from the controller API to the controller such that the controller operates the device, and (7) operating the device in accordance with the request.

The recording medium according to still another aspect of the present invention is a recording medium recording a program for offering a service based on an application to a user in such a manner that an electronic appliance controls a device via a controller. The program allows a computer of the electronic appliance to execute the steps of receiving a command from the user so as to start the application prepared with the use of an API. The program further allows a computer the steps of loading a correlation information between the application and the API from a storing unit, and calling a secondary API on the basis of the correlation information having an interface not to be implemented in a controller API. The program will then cause the computer to perform the steps of (1) starting up the application with the use of the interface in the secondary API when version information of the API is newer than version information of the controller API, (2) calling the controller API, (3) issuing a request from the controller API to the controller such that the controller operates the device, and (4) operating the device in accordance with the request.

Herein, the secondary API may cancel differences between the version on the API used upon preparation of the application and the version of the controller API.

With these configurations, the interface of the secondary API is different from the interface of the controller API. Even when the version information of the API is newer than the version information of the controller API, the application prepared with the use of the API can run with certainty.

Furthermore, the secondary API cancels the difference between the version information of the API used upon preparation of the application and the version information of the controller API. This configuration eliminates a necessity of developing an application for each type of various electronic appliances.

Further, the application managing unit issues a request to the selected application such that the application runs on the basis of the stored correlation information to call the secondary API; therefore, the application can run with certainty.

Having thus described in detail preferred embodiments of the present invention, it is to be understood that the invention defined by the foregoing paragraphs is not to be limited to any particular details and/or embodiments set forth in the above description, as many apparent variations thereof are possible without departing from the spirit or scope of the present invention.

What is claimed is:

1. An electronic appliance for controlling a device via a controller, comprising:
an application managing unit that manages an application which is prepared with the use of an API, wherein the application operates the device to offer a service to a user;
a storing unit that stores information about a correlation between the application and the API;
a controller API that is called by the application, and issues one or more requests to the controller such that the controller operates the device; and
a secondary API that has an interface not implemented in the controller API which starts up the application with the use of the interface when version information of the API is newer than version information of the controller API.

2. The electronic appliance according to claim 1, wherein
the secondary API is called by the application on the basis of the correlation information.

3. The electronic appliance according to claim 1, wherein
the application is selected upon activation of the electronic appliance.

4. The electronic appliance according to claim 1, wherein
the secondary API supports a pseudo service different from the service based on the application; and
the controller API issues the request corresponding to the pseudo service.

5. The electronic appliance according to claim 4, wherein
at least one pseudo service supported by the secondary API is a 2-in-1 printing.

6. The electronic appliance according to claim 1, wherein
the secondary API notifies the user when the service based on the application is unavailable.

7. The electronic appliance according to claim 1, wherein
the secondary API is packaged together with the application, and is installed together with the application on the electronic appliance only in a case where the version information of the API is newer than the version information of the controller API at a time when the application is installed on the electronic appliance.

8. A method for offering a service based on an application to a user in such a manner that an electronic appliance controls a device via a controller, the method comprising the steps of:
receiving a command from a user to start up the application prepared with the use of an API;
loading the correlation information between the application and the API from a storing unit;
calling a secondary API on the basis of the correlation information having an interface not to be implemented in a controller API;
starting up the application with the use of the interface in the secondary API when version information of the API is newer than version information of the controller API;
calling the controller API;
issuing a request from the controller API to the controller such that the controller operates the device; and
operating the device in accordance with a request.

9. A recording medium recording a program for offering a service based on an application to a user in such a manner that an electronic appliance controls a device via a controller, the program allowing a computer of the electronic appliance to execute the steps of:
receiving a command from the user so as to start the application prepared with the use of an API;
loading a correlation information between the application and the API from a storing unit;
calling a secondary API on the basis of the correlation information having an interface not to be implemented in a controller API;
starting up the application with the use of the interface in the secondary API when version information of the API is newer than version information of the controller API;
calling the controller API;
issuing a request from the controller API to the controller such that the controller operates the device; and
operating the device in accordance with a request.

10. The recording medium of claim 9, wherein
the secondary API cancels differences between the version of the API used upon preparation of the application and the version of the controller API.
